(19) United States
(12) Patent Application Publication
(10) Pub. No.: US 2025/0256951 A1
(43) Pub. Date: Aug. 14, 2025

(54) BEVERAGE DISPENSING SYSTEM

(71) Applicant: ECOSPIRITS PTE. LTD., Singapore (SG)

(72) Inventors: Paul Pascal GABIE, Singapore (SG); Shanshan ZHANG, Singapore (SG)

(21) Appl. No.: 18/856,826

(22) PCT Filed: Apr. 14, 2023
(86) PCT No.: PCT/SG2023/050255

§ 371 Date: Oct. 14, 2024

(30) Foreign Application Priority Data
Apr. 14, 2022 (SG) 10202203920U

(51) Int. Cl. B67D 1/08; B67D 1/12

(52) U.S. Cl. CPC B67D 1/0888; B67D 1/0875; B67D 1/1234

(57) ABSTRACT

A beverage dispensing apparatus comprising a body for engaging a replaceable fluid receptacle; an extractor for extracting fluid from the receptacle; a controller comprising two or more volume selectors for controlling extraction, by the extractor, of a respective predetermined volume of the fluid from the receptacle; a dispenser for dispensing the fluid, extracted by the extractor, into a container; and a reader for reading an identifier on the receptacle, wherein a processor is configured to receive, from the reader, data comprising the identifier and verify the identifier based on one or more conditions, wherein if the identifier satisfies the one or more conditions the controller is operable to control extraction of the fluid from the receptacle and if the identifier does not satisfy at least one said condition the controller cannot be operated to extract fluid from the receptacle.

### TECHNICAL FIELD

The present invention relates, in general terms, to a beverage dispensing apparatus, and also relates to a system comprising a plurality of the beverage dispensing apparatus.

### BACKGROUND

In the spirits distribution industry, up to 70% of the base cost of goods sold (COGS) in bottled spirits is comprised of packaging- or supply chain-related components. These components include glass bottles, paper labels, stoppers, other packaging elements, cardboard boxes, pallets, logistics and all related labour at each step in the production, distribution and consumption value chain.

Current packaging technology and distribution practices for spirits create enormous amounts of waste. It is desirable therefore to provide a device or apparatus that removes or ameliorates the abovementioned drawbacks.

Existing liquid dispensing systems are available, in which a glass depresses a stopper to dispenser a fluid. Such systems do not solve problems relating to circular packaging and closed loop beverage distribution. Existing dispensing systems do not enable an automated, hygienic, one-button transfer of spirits or wine from the system to a bottle or vessel used to serve the consumer in a hospitality venue (bars, restaurants and hotels).

Existing liquid dispensing systems are also unable to solve the supply chain visibility problem and therefore cannot be used for stock level management, sales insights, and supply chain security.

It would be desirable to overcome all or at least one of the above-described problems.

### SUMMARY

Beverage dispensing apparatus disclosed herein can be used to record and report data related to the transfer/consumption of wine and spirits from liquid dispensing systems, in hospitality venues. The apparatus can also be used to verify the origin of beverages and the like, to ensure authenticity and to secure the supply chain.

Disclosed herein is a beverage dispensing apparatus comprising:
a body for engaging a replaceable fluid receptacle;
an extractor for performing an extraction process by extracting fluid from the receptacle;
a controller comprising two or more volume selectors for controlling extraction, by the extractor, of a respective volume of the fluid from the receptacle;
a dispenser for dispensing the fluid, extracted by the extractor, into a container; and
a reader for reading an identifier on the receptacle/container, wherein a processor is configured to receive, from the reader, data comprising the identifier and verify the identifier based on one or more conditions, wherein if the identifier satisfies the one or more conditions the controller is operable to control extraction of the fluid from the receptacle and if the identifier does not satisfy at least one said condition the controller cannot be operated to extract fluid from the receptacle.

The terms “extraction process” and “dispensing process” can be used interchangeably unless context dictates otherwise. They will be taken to refer to the process of extracting a volume fluid from the receptacle and dispensing that volume into a vessel (or otherwise out of the apparatus). Between the receptacle and when the fluid exits the apparatus, the fluid passes along a flow path—e.g. in tubing.

In some embodiments, the body is a housing that substantially encloses the receptacle.

In some embodiments, the housing comprises a window through which part of the receptacle is visible.

In some embodiments, the housing comprises a lighting unit in the window configured to illuminate the part of the receptacle.

In some embodiments, the processor is in communication with memory, wherein data corresponding to the extracted volumes of the fluid is stored in the memory.

In some embodiments, the memory is configured to store time/date of each extraction process.

In some embodiments, the identifier is configured to identify a type of the fluid and the receptacle itself.

In some embodiments, the processor is configured to monitor a volume of vessel and:
notify when the receptacle is empty;
disallow more than a total volume of the vessel to be dispensed from the receptacle; and
calculate an overall inventory level of the fluid and determine, based on the overall inventory level, whether to notify of a need to order more of the fluid.

In some embodiments, the beverage dispensing apparatus further comprises a battery for powering the apparatus.

In some embodiments, the apparatus further comprises the processor.

Disclosed herein is also a system comprising a plurality of the beverage dispensing apparatuses according to any one of 1 to 10; and a system processor configured to:
record all dispensing/extraction processes over all the apparatuses;
determine an overall inventory level based on combined volumes of the receptacles in the plurality of apparatuses; and
notify the need to order more of the fluid when the inventory level drops below a predetermined threshold.

In some embodiments, the system processor is further configured to notify of an attempt to extract fluid from a receptacle that could not be verified.

In some embodiments, the beverage dispensing apparatuses are configured to communicate wirelessly with the system processor.

### BRIEF DESCRIPTION OF THE DRAWINGS

Embodiments of the present invention will now be described, by way of non-limiting example, with reference to the drawings in which:

FIG. 1 illustrates an example beverage dispensing apparatus;

FIG. 2 illustrates another example beverage dispensing apparatus with one or more volume selectors;

FIG. 3 illustrates another example beverage dispensing apparatus with a flowmeter or other device for measuring a volume (including weight or another proxy for volume) dispensed;

FIG. 4 shows a plurality of components installed on an example printed circuit board;

FIG. 5 is a schematic diagram showing components of an exemplary computer system for performing the methods described herein;

FIG. 6 illustrates an example supply chain management system; and

FIG. 7 illustrates an example coupling design for pressure sealing in the replaceable fluid receptacle.

### DETAILED DESCRIPTION

The present invention relates to a beverage dispensing apparatus. The proposed beverage dispensing apparatus is an electronic accessory for seamless, hygienic in-venue dispensing and sustainable refilling. Some embodiments facilitate circular packaging (e.g. sterilisation and reuse) and closed loop beverage distribution. The proposed circular packaging solutions incorporate the principles of the circular economy and integrate seamlessly into sustainability efforts. The proposed beverage dispensing apparatus is also an electronic closed loop device that automatically regulates the beverage dispensing process variables desired states without human interaction. In particular, when operated as a closed loop and circular packing system, the beverage dispensing apparatus eliminates more than 95% of the packaging waste and as much as 80% of the carbon footprint of beverage distribution and consumption.

Beverage dispensing apparatuses disclosed herein can solve the liquid transfer problem through electronic pouring control. Such apparatuses can also enable an automatic, hygienic, one-button transfer of a beverage (e.g. spirit or wine) from a fluid receptacle to the bottle or vessel used to serve the consumer in a hospitality venue such as a bar, restaurant or hotel. The apparatus supports pouring with programmable buttons for set dispense measures—e.g. dispensing (i.e. extracting from the receptacle and dispensing into a vessel) a selectable/programmable predetermined volume of fluid. The proposed beverage dispensing apparatus offers hospitality venues a range of performance upgrades over prior manual transfer solutions, improving speed, hygiene, and accuracy. Each apparatus is water resistant, easy to clean, and transitions seamlessly between beverage types.

The proposed beverage dispensing apparatus can also solve the supply chain visibility problem by connecting the apparatus wirelessly to servers through a Wi-Fi (or hardwired) module. The apparatus can record and report all data related to the transfer/consumption of beverage in the hospitality. The proposed apparatus also provides sensing and data reporting to track liquid dispensing processes and to verify the supply chain in a closed loop system. In this context, verifying the supply chain includes ensuring the authenticity of the fluid being dispensed, such that it can be tracked back to a particular supplier authorised to dispense that fluid. The apparatus can also, or alternatively, be used to monitor the volume of the fluid from the receptacle enclosed in it as well as the consumption of beverage in a hospitality venue so as to decide whether or not certain actions should be taken in order to ensure supply chain stability and efficiency. The data reporting/recording features are valuable to users of the apparatus in managing the sustainability impact of the closed loop and circular packing system.

Last but not least, the proposed beverage dispensing apparatus can solve the aesthetic presentability problem for closed loop packaging formats. In some embodiments, the apparatus is designed to be coupled with a fluid receptacle, which is used for containing the beverage. While in use, the proposed dispensing apparatus is used to dispense the beverage contained in the fluid receptacle. It will be appreciated that the fluid receptacle may have in a particular shape or condition that is not presentable. For example, the receptacle may show the wear and tear on the surface/body of the receptacle and may not be presentable to the users. This often occurs while receptacles are in transit or in storage for extended periods. In such case, the proposed apparatus can solve the problem of aesthetics/visuals of reusable vessels in a front-of-house environment by at least partially, or even fully, enclosing the fluid receptacle.

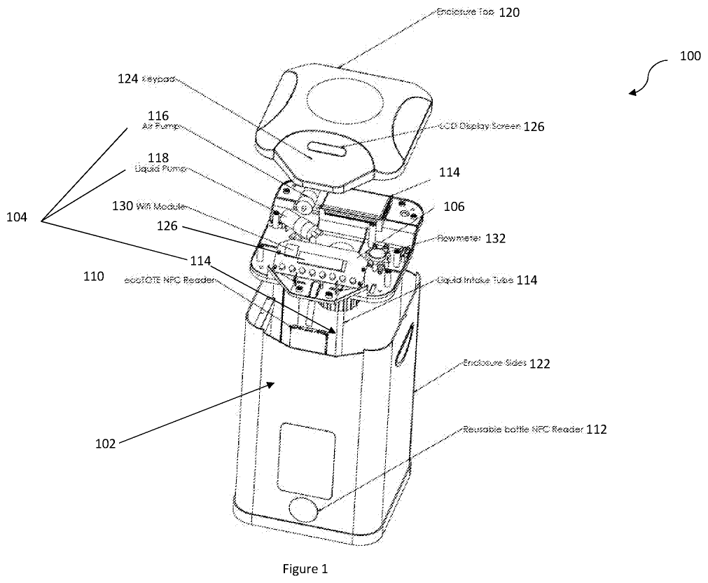

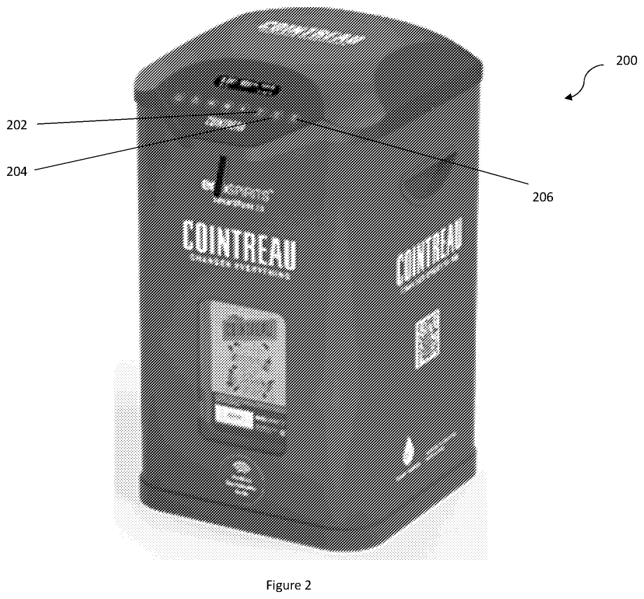

FIG. 1 illustrates an example beverage dispensing apparatus 100. The beverage may be a spirit such as a distilled, consumable spirit, e.g. vodka, rum, tequila, whisky, gin or other type of spirit or liqueur. It will be appreciated that the beverage dispensing apparatus 100 can be powered by a battery. The beverage dispensing apparatus 100 broadly comprises:
a body 102 for engaging a replaceable fluid receptacle (not shown);
an extractor 104 for extracting fluid from the receptacle;
a controller 106 comprising two or more volume selectors (e.g. the volume selectors 202 as shown in FIG. 2) for controlling extraction, by the extractor 104, of a respective predetermined volume of the fluid from the receptacle;
a dispenser 108 for dispensing the fluid, extracted by the extractor 104, into a container (e.g. a reusable bottle); and
one or more readers 110/112 for reading an identifier on the receptacle/container, wherein a processor 114 is configured to receive, from the reader data comprising the identifier and verify the identifier based on one or more conditions,
wherein if the identifier satisfies the one or more conditions the controller 106 is operable to control extraction of the fluid from the receptacle and if the identifier does not satisfy at least one said condition the controller 106 cannot be operated to extract fluid from the receptacle.

The replaceable fluid receptacle is used to contain the liquid. The liquid may be a spirit such as a distilled, consumable spirit—e.g. vodka, rum, tequila, whisky, gin or other type of spirit or liqueur. The body 102 may be a protective housing, which may also be referred to as a protective enclosure.

Since spirits are generally solvents, the replaceable fluid receptacle should be resistant to dissolution. While the replaceable fluid receptacle may be formed from any suitable material, the present replaceable fluid receptacle is formed from glass though, in some embodiments, metal or some plastics may be used. Advantageously, the body 102 is capable of protecting similar fluid receptacle formed from other materials that are rigid in the sense of being frangible or brittle. It will be appreciated that the body 102 shall also be resistant to dissolution in the event of a leak of liquid from the replaceable fluid receptacle.

Since the replaceable fluid receptacle is protected by the body 102 against some impacts, it may have a larger capacity than standard 750 ml or IL spirits bottles. For example, the replaceable fluid receptacle may have a capacity of 1.5L, 2.0L, 2.25L, 3.0L, 3.75L, 4.0L, 4.5L, 9.0L or another desired volume. In preferred embodiments, the volume of the replaceable fluid receptacle is a whole multiple of a standard volume spirits bottle. Thus, the replaceable fluid receptacle will be emptied upon complete filling of a particular number of spirits bottles. The body 102 may have a capacity slightly larger than that of the replaceable fluid receptacle so as to engage the receptacle. In preferred embodiments, the body 102 is able to engage replaceable fluid receptacle with different volumes, thus making it unnecessary to design different sizes of the body 102.

The body 102 may be any desired shape. In some embodiments, the body 102 is cylindrical. Thus, the body 102 may have a circular cross-section. The skilled person will appreciate that the term “cylindrical” does not mean the ends of the body 102 terminate exactly at right angles with the sidewall of the body 102. Rather, the present body 102 and thus replaceable fluid receptacle may be cylindrical in a similar sense of a standard wine or spirit bottle being cylindrical.

The body 102 substantially encloses the fluid receptacle in use. The body 102 comprises an enclosure top 120, and a plurality of enclosure slides 122 for enclosing the fluid receptacle. The body 102 may be formed from any desired material, such as injection moulded plastic. However, the body 102 is presently formed from a deformable, or readily deformable, material such as aluminium. This ensures the body 102 will preferentially collapse, as opposed to fracturing of the fluid receptacle, if the dispensing apparatus 100 is dropped. The body 102 is therefore sacrificial.

As shown in FIG. 1, the body 102 is a housing that substantially enclose the receptacle, making the receptacle visually presentable through the enclosed design. The receptacle may be fully enclosed with only the brand plate of the receptacle visible. The receptacle may be in a particular shape which is not presentable. For example, the exposed areas of the fluid receptacle are usually protected from impacts by a handle extending across the exposed area. Showing the wear and tear of the handle may be not presentable to the users. The proposed apparatus can solve the problem of aesthetics/visuals of reusable vessels in a front-of-house environment by substantially enclosing the fluid receptacle. Such design also allows for complete aesthetic coverage of other areas of the fluid receptacle that suffer damages during closed loop operations.

As shown in FIG. 1, the housing 102 comprises a window 112 through which part of the receptacle is visible. In the present disclosure, the window 112 is used for viewing brand, volume, and product information. In particular, the receptacle may comprise a brand plate showing the product name, volume, alcohol percentage and other information. The users can read the above information printed on the brand plate through the window 112. It will be appreciated that the users of the beverage dispensing apparatus 100 may have the need to check frequently the condition of the fluid receptacle enclosed by the body 102. For example, the alcohol consumers may want to visually check the quality of the spirit contained in the fluid receptacle. The supply chain maintainers may need to check whether the fluid receptacle has suffered damages during closed loop operations. Removing the receptacle from the housing 102 to check the condition of the receptacle is time-consuming and thus inefficient. It will be appreciated checking the condition of the receptacle as well as other parts of the apparatus 102 through the window helps to ensure the supply chain stability and efficiency.

In some embodiments, the housing 102 comprises a lighting unit (not shown) in the window 112 configured to illuminate the part of the receptacle. The lighting unit is used to display part of the receptacle that is interested to the users of the beverage dispensing apparatus 100 in a low light environment. The housing may comprises a light switch. When a user of the apparatus 100 finds the surroundings too dim to visually check the condition of the receptacle (e.g. by reading the brand plate on the receptacle) through the window, he/she can operate the light switch to turn on the lighting unit. It will be appreciated that the lighting unit may be automatically illuminated in low conditions. In particular, the lighting unit may further comprise light sensors (such as photosensitive sensors) such that when the surrounding luminosity is below a certain value, the lighting unit will be turned on to illuminate the receptacle, and when the surrounding luminosity is higher than a certain value, the lighting unit will be turned off to save power.

As shown in FIG. 1, the extractor 104 comprises a liquid intake tube 114, an air pump 116, and a liquid pump 118. Since spirits are generally solvents, the extractor 104 may also be resistant to dissolution. In the present disclosure, the air pump 116 is configured to blow out leftover fluid in the flowmeter and dispensing tap (i.e., the fluid in a flow path from the receptacle to the container into which the fluid is dispensed). The air pump 116 helps avoid drips after dispensing. It also assists with purging/flushing of the apparatus 100 after dispensing or after cleaning. This ensures cleanliness of the apparatus, i.e. the flow path, and avoids cross-contamination of fluids. In another example, the air pump 116 is configured to provide atmosphere pressure for the beverage to flow out of the receptacle through the liquid intake tube 114 to the liquid pump 118—i.e. displacing beverage (interchangeably referred to as fluid unless context dictates otherwise) from the receptacle by at least partially filling the receptacle with gas. The liquid pump 118 is then configured to drive the beverage to the dispenser 108. In the embodiment as shown in FIG. 1, the extractor 104 is supported by the body 102. Such design allows the liquid intake tube 114 to naturally extend into the receptacle when the receptacle is installed in the body 102, and also reduces the impact of the pump 116/118 vibration on the extraction process when the pumps 116/118 are operating. It will also be appreciated that the length of intake tube 114 can be adjusted according to the depth of the receptacle so that all the beverage inside the receptacle can be extracted.

The controller 106 comprises two or more volume selectors. In some embodiments for example shown in FIG. 1, the volume selectors (not shown) are placed on the keypad 124 of the enclosure top 120. When in use, the users of the apparatus 100 tap each volume selector representing a respective volume of the fluid, and the fluid of that respective volume will then be dispensed from the apparatus 100. A LCD display screen 126 may be used to display the optional volume for select. In the present disclosure, the volume selectors are physical buttons. It will be appreciated that the volume selectors can also be capacitive touch buttons or other types of buttons, and the display can be a type of display that is suitable for use rather than being limited to a LCD display. In another example, the volume selectors are integrated with the touch-screen LCD display screen 126 so that the user can select a volume by simply touching the display screen 126. FIG. 2 shows another example beverage dispensing apparatus 200. The apparatus 200 provides a one-push pour at 120 ml (see 202), 250 ml (see 204), and 750 ml (see 206) volumes, along with a continuous pour option for any desired fill volume. Each volume selector of 202, 204, and 206 is used for controlling extraction, by the extractor, of a respective predetermined volume of the fluid from the receptacle. It will be appreciated that the volume of the replaceable fluid receptacle may be a whole multiple of each respective predetermined volume. Thus, the replaceable fluid receptacle will be emptied after a number of predetermined volumes of containers have been completely filed. As will be discussed in details, the controllers can be installed on a printed circuit board (PCB).

The apparatus 100 also comprises one or more readers, the present embodiment including a plurality of different readers 110/112, for reading an identifier on the receptacle/container. In one example, the reader 110 is a near-field communication (NFC) reader for checking the condition of the receptacle. The NFC reader 110 is a simple tool letting the users to read contact-less tags on the receptacle. In other examples, the reader 110 could also be QR code scanner, barcode scanner or other suitable reader technology. The reader 110 can be used to check receptacle-related data comprising the volume of the fluid in the receptacle, the fluid type, the fluid temperature, as well as the fluid flow rate for dispensing—e.g. by reading the identifier and cross-referencing the identifier with a database, or the identifier being an address or pointer to data describing the receptacle and/or its contents. It will be appreciated that the receptacle-related data can be collected by a plurality of sensors that may/may not be installed on the apparatus 100. As shown in FIG. 1, the apparatus 100 comprises a flowmeter 132 for detecting the fluid flow rate for dispensing as well as the extracted volumes of the fluid. In the present disclosure, the flowmeter 132 counts rotations and determines dispensed volume based on the number of rotations. The liquid dispenser works with the flowmeter 132 to avoid counting rotations when the flow meter is being driven by air. A liquid sensor (not shown in FIG. 1) detects the presence of liquid in flow/dispensing tubing through which the fluid passes from the receptacle during dispensing. The liquid sensor or another sensor may also be used to check the fluid type/temperature of the fluid. The sensors such as 130 may send the collected data comprising the identifier to the reader 110, and the processor 114 then communicates with the reader 110 to collect data from the apparatus to perform the corresponding operations according to the collected data. In some instances, the processor (which can be a single processor multiple processors) is part of the apparatus itself and in other instances the processor is remote from the apparatus. In particular, if the identifier satisfies one or more conditions (e.g. that the identifier corresponds to a receptacle that has been confirmed as having previously arrived at the relevant venue, that it is known to not yet be empty of fluid, and that the volume of fluid is at least sufficient to dispense the volume determined by the button selected by the user) the controller is operable to control extraction of the fluid from the receptacle and if the identifier does not satisfy at least one said condition the controller cannot be operated to extract fluid from the receptacle. For example, if the liquid sensor detects that the temperature of the fluid is above a predetermined value, the controller will not be operated to extract the fluid from the receptacle.

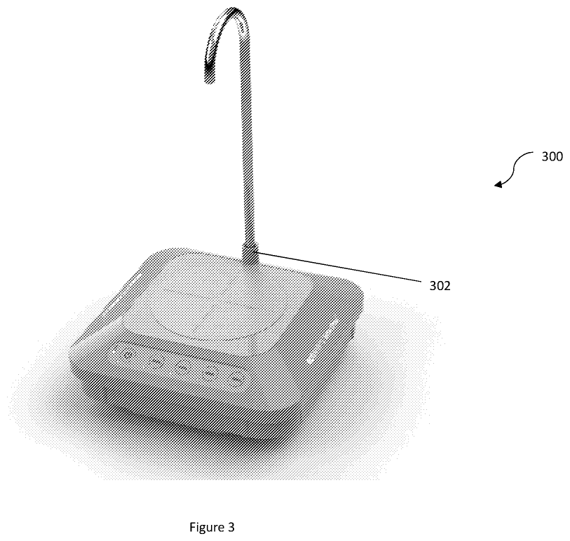

In one example, the reader 112 is a NFC reader for checking the condition of the container. The NFC reader 112 is a tool letting the users to read contact-less tags on the container. In other examples, the reader 112 could also be QR code scanner or use other suitable reader technologies. The reader 112 can be used to check container-related data comprising the volume of the fluid in the container, the fluid type, the fluid temperature, as well as the fluid flow rate for dispensing. The container-related data can also be collected by a plurality of sensors that may/may not be installed on the apparatus 100. FIG. 3 shows another example beverage dispensing apparatus 300. As shown in FIG. 3, the apparatus 300 comprises a flowmeter 302 (or the flowmeter 302 in conjunction with other sensors, or a weight sensor for detecting weight which is a proxy for volume) for detecting the volumes of the fluid in the container. A liquid sensor (not shown in FIG. 3) may also be used to check the fluid type/temperature of the fluid in the container. The sensors such as 302 may send the collected data to the reader 110, and the processor 114 then communicates with the reader 112 so as to do the corresponding operations according to the collected data. In particular, if the identifier satisfies one or more conditions the controller is operable to control extraction of the fluid from the receptacle and if the identifier does not satisfy at least one said condition the controller cannot be operated to extract fluid from the receptacle. For example, if the flowmeter 302 detects that the volume of the container is at or above a predetermined value, the controller will not be operated to extract the fluid from the receptacle.

In some embodiments, the processor 114 is installed in the apparatus 100. In other words, the apparatus 100 further comprises the processor. In such case, the processor 114 may also be on the PCB 128. In some other examples, the processor 114 can be remote. Such design allows for remote service implementations. The remote processor may be able to control a plurality of different replaceable fluid receptacles, for example the receptacles in a same hospitality venue such as bar, restaurant and hotel. As will be discussed in detail, the present invention also relates to a system comprising a plurality of beverage dispensing apparatuses controlled by a single processor. In such case, the processor is able to communicate with multiple readers on different apparatuses so as to do the corresponding operations according to the collected data from different readers. The apparatuses in the same hospitality as a whole can record and report all data related to the transfer/consumption of beverage in the hospitality. As a result, the supply chain visibility problem can be solved by connecting different apparatuses in the same hospitality wirelessly (e.g. through the Wi-Fi module 130) to the same processor. The consumption of beverage in the hospitality can be validated so as to allow the processor to decide whether or not certain actions should be taken in order to ensure supply chain stability and efficiency.

In some embodiments, the processor 114 does not communicate with the readers 110/112 or sensors directly. Instead, the processor is in communication with memory, which may be installed in the apparatus 100. The purpose of this design is to avoid channel clogging caused by the processor having to communicate with targets (i.e., the sensors and readers). The memory is configured to store data corresponding to the extracted volumes of the fluid. The memory can also comprise other data comprising the volume of the fluid in the receptacle/container, the fluid type, the fluid temperature, as well as the fluid flow rate for dispensing. The memory is able to integrate different information so as to allow the processor to decide whether or not certain actions should be taken according to the information from different sources. In one example, the processor 114 will allow the controller to operate so as to extract the fluid from the receptacle only if the following two conditions are both satisfied: 1) the weight of the container is not above a predetermined value; and 2) the extracted volumes of the fluid is not above a predetermined value. In particular, the weight of the container may be detected by a weight sensor while the extracted volumes of the fluid are detected by the flowmeter 302. The memory will integrate the data collected from both the weight sensor and flowmeter 302, and if at least one of the above two conditions not satisfied, the processor will decide that the controller cannot be operated to extract fluid from the receptacle.

The memory can also store the time/date of each extraction process. In general, the supply chain management problem can be solved by connecting different memory (installed on different apparatus) that stores the extraction time information to the same processor. As mentioned earlier, the present invention relates to a system comprising a plurality of beverage dispensing apparatuses controlled by a single processor. The apparatuses in the same hospitality venue as a whole can record and report all data related to the transfer/consumption of beverage in the hospitality venue. In such case, each memory can store the time/date of extraction process related to a respective apparatus. The processor is able to communicate with the memory on different apparatuses so as to do the corresponding operations according to the stored data from each memory or all the memories collectively. For example, the processor can determine which apparatus is used more frequently and which apparatus is used less frequently according to the time/date of each extraction process stored in different memory. The processor can then decide that the controller on a frequently used apparatus cannot continue to operate to avoid excessive wear on the apparatus, or that apparatuses/receptacles should be swapped over to avoid fluid expiration in another less frequently used apparatus.

In some embodiments, the identifier received from the reader 110/112 is able to identify a type of fluid in the receptacle/container and the receptacle/container itself. The fluid may be a spirit such as a distilled, consumable spirit, e.g. vodka, rum, tequila, whisky, gin or other type of spirit or liqueur. Different spirits may need different receptacles/containers. For example, if the spirit is whisky, it usually needs to be stored in a whiskey decanter rather than other containers. In one embodiment, if the processor detects that the fluid for dispensing is whiskey, and the container for receiving the fluid is not a whiskey decanter, the processor will not allow the controller to operate to extract the fluid from the receptacle to the container. In addition, as spirits are generally solvents, the replaceable fluid receptacle as well as the container should be resistant to dissolution. In another embodiment, if the processor detects that the container for receiving the spirits is not resistant to dissolution, the processor will not allow the controller to operate to extract the fluid from the receptacle to the container.

In some embodiments, the processor 114 continually monitors a volume of vessel. The volume of the vessel may be detected by the flowmeter 132. The processor 114 is able to determine whether the receptacle is empty according to the extracted volumes of the fluid. When the receptacle is empty, the processor 114 will prevent the controller from working, so that the air pump 116 and liquid pump 118 will not idle. The processor 114 will also notify and send an alert to the users of the apparatus 100 for replacing the receptacle.

The processor 114 may disallow more than a total volume of the vessel to be dispensed from the receptacle. The maximum volume of the vessel that can still be extracted from the receptacle can be calculated according to the data regarding the extracted volumes of the fluid that is collected by the flowmeter 132. The maximum volume of the vessel to be extracted from the receptacle can also be determined by reference to the identifier or by the vessel having a standard volume. For example, if there is only 600 ml spirit in the receptacle, and the user taps the button “750 ml” for dispensing the spirit, the processor 114 will disallow the controller to operate, or only allow the controller to operate until 600 ml spirit has been dispensed. In the latter case, when the receptacle is empty, the processor 114 will prevent the controller from working, so that the air pump 116 and liquid pump 118 will not idle.

In some embodiments, the processor 114 is also able to calculate an overall inventory level of the fluid and determine, based on the overall inventory level, whether to notify of a need to order more of the fluid. For example, if there is only 100 ml spirit in the receptacle, the processor 114 will notify the users to order more of the fluid. The reason why the processor 114 does not wait until the receptacle is empty to notify the users is that the alcohol producers may need time to produce and deliver the additional liquids, and leaving the receptacle empty can be detrimental to the stability of the supply chain. It will be appreciated that the processor 114 may automatically order more of the fluid based on the inventory level, and the efficiency of the supply chain would thus be enhanced by the absence of human intervention.

The present invention also relates to a system comprising a plurality of the proposed beverage dispensing apparatuses, and each apparatus is able to communicate wirelessly with the system operator. In such case, the processor of the system can be remote. The remote system processor may be able to control a plurality of different replaceable fluid receptacles, for example the receptacles in a same hospitality venue such as bar, restaurant and hotel. The apparatuses in the same hospitality as a whole can record and report all data related to the transfer/consumption of beverage in the hospitality. As a result, the supply chain visibility problem can be solved by connecting different apparatuses in the same hospitality wirelessly to the same system processor.

In some embodiments, the system processor continually records all dispensing/extraction processes over all the apparatuses. For example, the volume of the vessel may be detected by the flowmeters installed on different apparatuses. The system processor is able to determine whether any receptacle in a hospitality venue is empty according to the extracted volumes of the fluid. When a specific receptacle is empty, the system processor will prevent the controller of that specific receptacle from working, so that the air pump and liquid pump of that specific receptacle will not idle. The system processor will also notify and send an alert to the users for replacing that specific receptacle.

The system processor may determine an overall inventory level based on combined volumes of the receptacles in the plurality of apparatuses. The system processor may further disallow more than a total volume of the vessel to be dispensed from the plurality of receptacles. The maximum volume of the vessel that can still be extracted from the plurality of receptacles can be calculated according to the data regarding the extracted volumes of the fluid that is collected by the flowmeters on the plurality of receptacles. The maximum volume of the vessel to be extracted from the receptacle can also be determined by reference to the identifier or by the vessel having a standard volume. For example, if there is only 60000 ml spirit in a hospitality venue, and there are 100 users who simultaneously tap the button “750 ml” for dispensing the spirit, the system processor will disallow the controllers of the apparatuses to operate, or only allow the controllers to operate until 60000 ml spirit has been dispensed.

In the latter case, when a receptacle of a specific apparatus is empty, the system processor will prevent the controller of that specific apparatus from working, so that the pumps on that specific apparatus will not idle.

In some embodiments, the system processor is also able to notify of a need to order more of the fluid when the inventory level drops below a predetermined threshold. For example, if there is only 10000 ml spirit in the receptacles in the same hospitality venue, the system processor will notify the users to order more of the fluid. The reason why the processor does not wait until all the receptacles are empty to notify the users is that the liquid producers may need time to produce and deliver the additional liquids, and leaving any of the receptacle empty can be detrimental to the stability of the supply chain. It will be appreciated that the system processor may automatically order more of the fluid based on the inventory level, and the efficiency of the supply chain would thus be enhanced by the absence of human intervention.

The system processor may be further configured to notify of an attempt to extract the fluid from a receptacle that could not be verified. In some other examples, the system processor may be further configured to notify of an attempt to extract the fluid to a container that could not be verified. The failure of verifying the receptacle/container may be due to the fact that the identifier does not satisfy at least one condition, and as a result the controller of that receptacle cannot be operated to extract fluid from the receptacle to the container. In some e notifying of the attempt to extract the fluid from a receptacle that could not be verified further comprises reporting the reason why the receptacle cannot be verified. Such design allows the users of the system to solve the verification problem quickly, thus brings benefits to the supply chain stability.

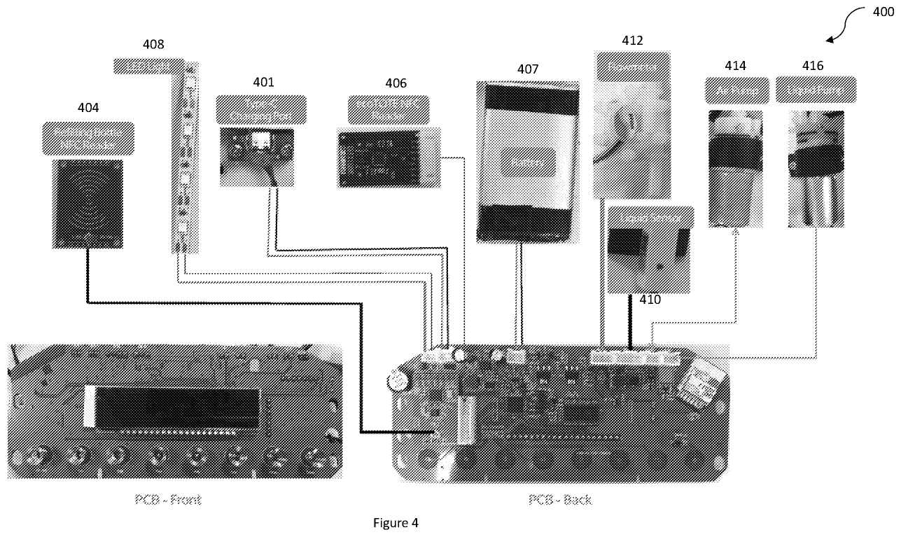

In the present invention, sensors, readers, the controller and processor can all be installed on a PCB. The advantages of using the PCB is that it can hold a large number of components, and as a result the size of the apparatus can be reduced. The components can be charged by a battery 407 or through a Type-C charging port 401. FIG. 4 shows an example PCB 402 with various components. In particular, the readers 404 and 406 may be used to check receptacle-related (or container-related) data which comprises the volume of the fluid in the receptacle/container, the fluid type, the fluid temperature, as well as the fluid flow rate for dispensing. The lighting unit 408 on the PCB is a LED displaying part of the receptacle that is interested to the users of the beverage dispensing apparatus in a low light environment. An air pump 414 is configured to blow out leftover fluid in the flowmeter and dispensing tap (i.e., the fluid in a flow path from the receptacle to the container into which the fluid is dispensed), or provide atmosphere pressure for the beverage to flow out of the receptacle through the liquid intake tube to a liquid pump 416. The liquid pump 416 may be used to drive the beverage to the dispenser. A liquid sensor 410 is also installed on the PCB to check the fluid type/temperature of the fluid. A flowmeter 412 is used for detecting the fluid flow rate for dispensing as well as the extracted volumes of the fluid. It will be appreciated that other sensors for sensing the type of the fluid and the receptacle/container itself may also be installed.

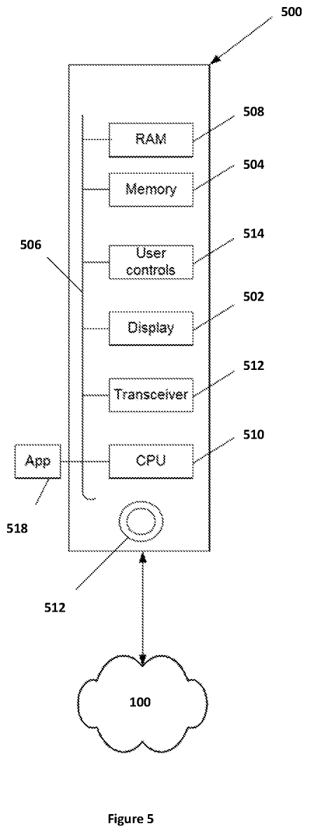

FIG. 5 is a block diagram showing an exemplary computer device 500, in which embodiments of the invention may be practiced. The computer device 500 can be installed on the PCB 402. The computer device 500 may be a mobile computer device such as a smart phone, a wearable device, a palm-top computer, and multimedia Internet enabled cellular telephones, an on-board computing system or any other computing system, a mobile device such as an iPhone™ manufactured by Apple™, Inc or one manufactured by LG™, HTC™ and Samsung™, for example, or other device.

As shown, the mobile computer device 500 includes the following components in electronic communication via a bus 506:
(a) a display 502;
(b) non-volatile (non-transitory) memory 504;
(c) random access memory (“RAM”) 508;
(d) N processing components 510;
(e) a transceiver component 512 that includes N transceivers; and
(f) user controls 514.

Although the components depicted in FIG. 5 represent physical components, FIG. 5 is not intended to be a hardware diagram. Thus, many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

The display 502 generally operates to provide a presentation of content to a user, and may be realized by any of a variety of displays (e.g., CRT, liquid crystal display (LCD), high definition multimedia interface (HDMI), micro-projector and organic light emitting diode (OLED) displays).

In general, the non-volatile data storage 504 (also referred to as non-volatile memory) functions to store (e.g., persistently store) data and executable code. The system architecture may be implemented in memory 504, or by instructions stored in memory 504.

In some embodiments for example, the non-volatile memory 504 includes bootloader code, modem software, operating system code, file system code, and code to facilitate the implementation components, well known to those of ordinary skill in the art, which are not depicted nor described for simplicity.

In many implementations, the non-volatile memory 504 is realized by flash memory (e.g., NAND or ONENAND memory), but it is certainly contemplated that other memory types may be utilized as well. Although it may be possible to execute the code from the non-volatile memory 504, the executable code in the non-volatile memory 504 is typically loaded into RAM 508 and executed by one or more of the N processing components 510.

The N processing components 510 in connection with RAM 508 generally operate to execute the instructions stored in non-volatile memory 504. As one of ordinarily skill in the art will appreciate, the N processing components 510 may include a video processor, modem processor, DSP, graphics processing unit (GPU), and other processing components.

The transceiver component 512 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The system 500 of FIG. 5 may be connected to any appliance 418, such as one or more cameras mounted to the vehicle, a speedometer, a weather service for updating local context, or an external database from which context can be acquired.

It should be recognized that FIG. 5 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 504. Non-transitory computer-readable medium 504 includes both computer storage medium and communication medium including any medium that facilitates transfer of a computer program from one place to another. A storage medium may be any available medium that can be accessed by a computer.

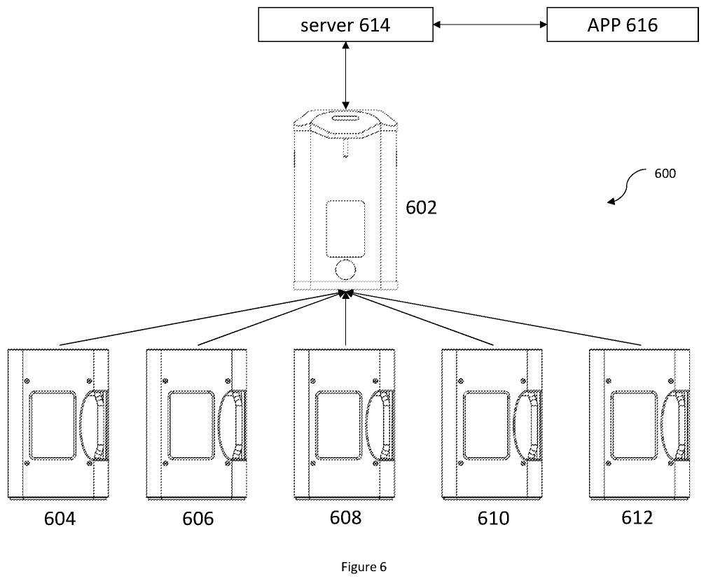

FIG. 6 illustrates an example supply chain management system 600 for the proposed beverage dispensing apparatus. As shown in FIG. 6, the beverage dispensing apparatus 602 is associated with a plurality of replaceable fluid receptacles 604, 606, 608, 610, and 612. The beverage dispensing apparatus 602 is also connected to a server 614, which can be controlled by a computer device (e.g. an APP 616 on a mobile phone). Initially, the replaceable fluid receptacle 604 is installed inside the apparatus 602. In one example, if the volume of the spirit in the receptacle 604 is below a predetermined value (e.g. less than 100 ml), the apparatus 602 will send a signal to the server through a Wi-Fi module 130 (see FIG. 1), which will then notify the users to order more of the fluid. The users can use the APP 616 to control the server so as to replace the receptacle 604 with another receptacle full of fluid (i.e., the receptacle 606, 608, 610, or 612). In general, the apparatus 602 can monitor the volume of the fluid from the receptacle enclosed in it as well as the consumption of beverage in the hospitality venue so as to decide whether or not certain actions should be taken in order to ensure supply chain stability and efficiency. The data reporting/recording features are valuable to the users of the apparatus as the sustainability impact of the closed loop and circular packing system.

The present invention also relates to a coupling design for pressure sealing in the replaceable fluid receptacle located inside the proposed beverage dispensing apparatus. Such coupling design can also be used in a glass bottle. The coupling includes two coupling members. A first coupling member engages (attaches to) the receptacle and is movably mounted to a second coupling member that is fixed on a body of a beverage dispensing apparatus such as apparatus 100. The coupling comprises a seal between the first coupling member a second coupling member. When the first coupling member engages the receptacle, weight of the receptacle causes movement between the first coupling member and second coupling member, thereby to compress the seal. Compression of the seal prevents liquid egress from between the coupling members. The first coupling member can therefore rotate with the receptacle while the second coupling member remains stationary on the beverage dispensing apparatus. This enables the receptacle to be connected to the beverage dispensing apparatus in a substantially leak-proof manner. The weight of the receptacle can be applied to the first coupling member by making the distance between the coupling and internal base of the beverage dispensing apparatus slightly longer than the receptacle (e.g. 1 mm), or otherwise such that the receptacle is suspended by the coupling above the internal base.

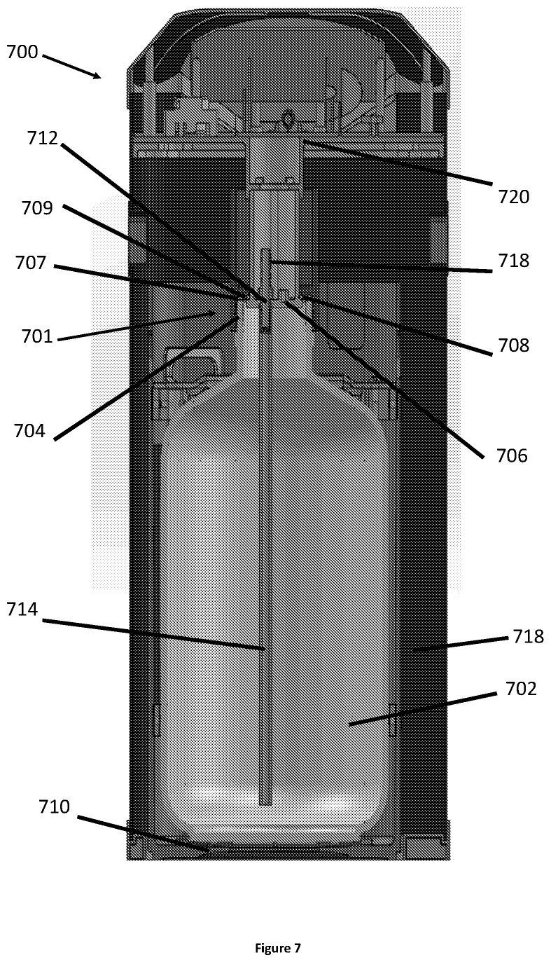

As shown in FIG. 7, the beverage dispensing apparatus 700 includes a platform 720 (also called a middle platform). The coupling 701 depends from the platform or is integral with the platform 720 as shown. A bridging tube part 712 of liquid intake tube 714 is mounted and fixed to the middle platform 720 of the beverage dispensing apparatus 716. Fixing can be using any appropriate means, e.g. screws 718. The bringing part 712 and tube 714, along with a pump and flow path (not shown) form part of the extractor. In the present embodiment, the replaceable fluid receptacle 702 comprises a thread. The thread engages a mating thread in the first coupling member 704. The first coupling member 706 may comprise a seal 707 to seal against the receptacle 702 when the receptacle 702 is engaged with the first coupling member 704—e.g. the first coupling member 706 is twisted onto the receptacle 702 (or the receptacle can be twisted into the coupling) until the seal is engaged. When a user starts to tighten the first coupling member (threaded knob/cap) 704 onto the receptacle 702, the thread will catch the replaceable fluid receptacle 702. The replaceable fluid receptacle 702 can be lifted up by the thread once the thread on the first coupling member has mated with the thread on the receptacle. After the replaceable fluid receptacle is fully threaded on, there would be a gap (e.g. 1 mm) between the receptacle 702 and the bottom surface 710 of the apparatus. The gap is designed to allow the threaded knob 704 to lift up the receptacle. That is, the receptacle 702 is hung when it is fully threaded on. The gravity of the receptacle 702 will pull downwardly on the threaded knob/cap 704, moving the threaded knob/cap in the direction of the bottom surface 710 relative to the second coupling member 706, since the first coupling member 704 is moveably mounted to the second coupling member 706 (e.g. in a sliding manner such that the knob/cap 704 can be moved up and down on the second coupling member 706). This squeezes/compresses the seal, presently sealing o-ring 708 between the first coupling member 704 and second coupling member 706, by engaging the sealing gasket 709 with the sealing o-ring 706 so as to seal the replaceable fluid receptacle 702 in the coupling 701.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A beverage dispensing apparatus comprising:
a body for engaging a replaceable fluid receptacle;
an extractor for performing an extraction process by extracting fluid from the receptacle;
a controller comprising two or more volume selectors for controlling extraction, by the extractor, of a respective volume of the fluid from the receptacle;
a dispenser for dispensing the fluid, extracted by the extractor, into a container; and
a reader for reading an identifier on the receptacle/container,
wherein a processor is configured to receive, from the reader, data comprising the identifier and verify the identifier based on one or more conditions, and
wherein if the identifier satisfies the one or more conditions the controller is operable to control extraction of the fluid from the receptacle and if the identifier does not satisfy at least one said condition the controller cannot be operated to extract fluid from the receptacle.

2. The beverage dispensing apparatus of claim 1, wherein the body is a housing that substantially encloses the receptacle.

3. The beverage dispensing apparatus of claim 2, wherein the housing comprises a window through which part of the receptacle is visible.

4. The beverage dispensing apparatus of claim 3, wherein the housing comprises a lighting unit in the window configured to illuminate the part of the receptacle.

5. The beverage dispensing apparatus of claim 1, wherein the processor is in communication with memory, wherein data corresponding to the extracted volumes of the fluid is stored in the memory.

6. The beverage dispensing apparatus of claim 1, wherein the memory is configured to store time/date of each extraction process.

7. The beverage dispensing apparatus of claim 1, wherein the identifier is configured to identify a type of the fluid and the receptacle itself.

8. The beverage dispensing apparatus of claim 1, wherein the processor is configured to monitor a volume of vessel and:
notify when the receptacle is empty;
disallow more than a total volume of the vessel to be dispensed from the receptacle; and
calculate an overall inventory level of the fluid and determine, based on the overall inventory level, whether to notify of a need to order more of the fluid.

9. The beverage dispensing apparatus of claim 1, further comprising a battery for powering the apparatus.

10. The beverage dispensing apparatus of claim 1, wherein the apparatus further comprises the processor.

11. A system comprising:
a plurality of the beverage dispensing apparatuses according to claim 1; and
a system processor configured to:
record all dispensing/extraction processes over all the apparatuses;
determine an overall inventory level based on combined volumes of the receptacles in the plurality of apparatuses; and
notify of a need to order more of the fluid when the inventory level drops below a predetermined threshold.

12. The system of claim 11, wherein the system processor is further configured to notify of an attempt to extract fluid from a receptacle that could not be verified.

13. The system of claim 11, wherein the beverage dispensing apparatuses are configured to communicate wirelessly with the system processor.
